(19) United States
(12) Patent Application Publication
(10) Pub. No.: US 2026/0162070 A1
(43) Pub. Date: Jun. 11, 2026

(54) SYSTEM & METHOD FOR REAL-TIME HOME SERVICE SCHEDULING

(71) Applicant: Timothy Wood, Fort Worth, TX (US)

(72) Inventor: Timothy Wood, Fort Worth, TX (US)

(21) Appl. No.: 18/977,450

(22) Filed: Dec. 11, 2024

(51) Int. Cl. G06Q 10/1093

(52) U.S. Cl. CPC G06Q 10/1093

(57) ABSTRACT

A method of online and mobile home services scheduling may include receiving, via a computing device, a user input of a service need from a user; generating, via the computing device, a list of currently available service providers based on real-time availability and geographic proximity to the user; receiving, via the computing device, user input requesting an appointment; receiving, via the computing device, provider input as at least one of a confirmation or a denial of the appointment; communicating, via the computing device, a notification to the user of the at least one of the confirmation or the denial of the appointment; completing the requested appointment comprising servicing the service need; and receiving, via the computing device, a user review of the servicing.

### TECHNICAL FIELD

The embodiments generally relate to the technical field of service scheduling based on real-time location and service schedule data.

### BACKGROUND

Conventional home service scheduling programs are software tools that help service-based businesses manage appointments, bookings, and team schedules effectively. These programs are commonly used by industries like cleaning, plumbing, HVAC, pest control, landscaping, and appliance repair.

Conventional home service scheduling programs often include online booking for customers, calendar integration, employee dispatching, reminders, and invoicing. Many programs also offer mobile apps for field workers to access schedules, update job statuses, and communicate.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A method of online and mobile home services scheduling may include receiving, via a computing device, a user input of a service need from a user; generating, via the computing device, a list of currently available service providers based on real-time availability and geographic proximity to the user; receiving, via the computing device, user input requesting an appointment; receiving, via the computing device, provider input as at least one of a confirmation or a denial of the appointment; communicating, via the computing device, a notification to the user of the at least one of the confirmation or the denial of the appointment; completing the requested appointment comprising servicing the service need; and receiving, via the computing device, a user review of the servicing.

In some aspects, a system of online and mobile home services scheduling includes at least one computing device in operable communication with a network and an application server in operable communication with the user network to host an application program configured to receive a user input of a service need from a user; generate a list of currently available service providers based on real-time availability and geographic proximity to the user; receive user input requesting an appointment; receive provider input as at least one of a confirmation or a denial of the appointment; and communicate a notification to the user of the at least one of the confirmation or the denial of the appointment.

In some aspects, a software product for online and mobile home services scheduling may include at least one computer readable storage media having application instructions collectively stored on the at least one computer readable storage media, the application instructions executable to: receive a user input of a service need from a user; generate a list of currently available service providers based on real-time availability and geographic proximity to the user; receive user input requesting an appointment; receive provider input as at least one of a confirmation or a denial of the appointment; and communicate a notification to the user of the at least one of the confirmation or the denial of the appointment

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a method of online and mobile home services scheduling, according to some embodiments; and

FIG. 4 illustrates a method of online and mobile home services scheduling, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

An online and mobile web application is disclosed, the application is designed to revolutionize the way users find and schedule home service providers. The application may be configured to connect users with service providers based on real-time availability, with a particular focus on facilitating same-day problem resolution. This approach marks a significant departure from existing technologies in the home services market.

The application may be configured to prioritize provider availability as the primary factor in search results and recommendations. Users begin by selecting their specific service needs and problems, presenting them with a list of available service providers in their area. This problem-centric approach ensures that users are matched with providers who are not only capable of addressing their specific issues but are also immediately available to do so. The platform displays real-time appointment slots for each provider, allowing users to make informed decisions based on factors such as reviews, estimated pricing, and availability.

The application may be configured to integrate online scheduling capability. Many existing websites and platforms in the home services industry lack this feature, often requiring users to make phone calls or use multiple platforms to book a service. The application may be configured to allow users to find and book services entirely within the app, streamlining the process and eliminating the need for phone calls. Once a user requests an appointment, they receive a confirmation from the service provider, further enhancing the seamless nature of the booking process.

This availability-first approach offers several improvements over existing technology. Unlike search engines or platforms that prioritize pay-per-click advertising or search engine optimization, the application may be configured to provide unbiased results based solely on provider availability. This not only offers a more equitable marketplace for service providers but also provides users with a more trustworthy and efficient experience. The platform effectively brings online scheduling capabilities to service providers who may not offer this feature on their websites, thus expanding the pool of easily bookable services.

By prioritizing availability and facilitating same-day services, the platform is uniquely positioned to address urgent home service needs more effectively than traditional platforms by making the process of finding and booking services as quick and easy as possible.

Implementations of the invention involve the technical field of computer-based real-time home service scheduling including generating a list of currently available service providers based on real-time availability and geographic proximity to the user (measured, for example, via GPS); receiving, via a computing device, user input requesting an appointment; receiving, via the computing device, provider input as at least one of a confirmation or a denial of the appointment; communicating, via the computing device, a notification to the user of the at least one of the confirmation or the denial of the appointment; and receiving, via the computing device, a user review of the servicing and are therefore necessarily rooted in computer technology. For example, the steps of generating a list of currently available service providers based on real-time availability and geographic proximity to the user (measured, for example, via GPS) is computer-based and cannot be performed in the human mind. The present invention amounts to more than merely implementing the generic computer as a tool to gather, analyze, and output data because the steps of the present method, system, or product improve the technical field of computer-based real-time home service scheduling by reducing computing resources needed to identify service providers. For example, by offering to schedule only geographically local service providers, the system reduces the need to identify, analyze, and schedule service providers outside of a reasonable geographic range, thereby reducing necessary computing power. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

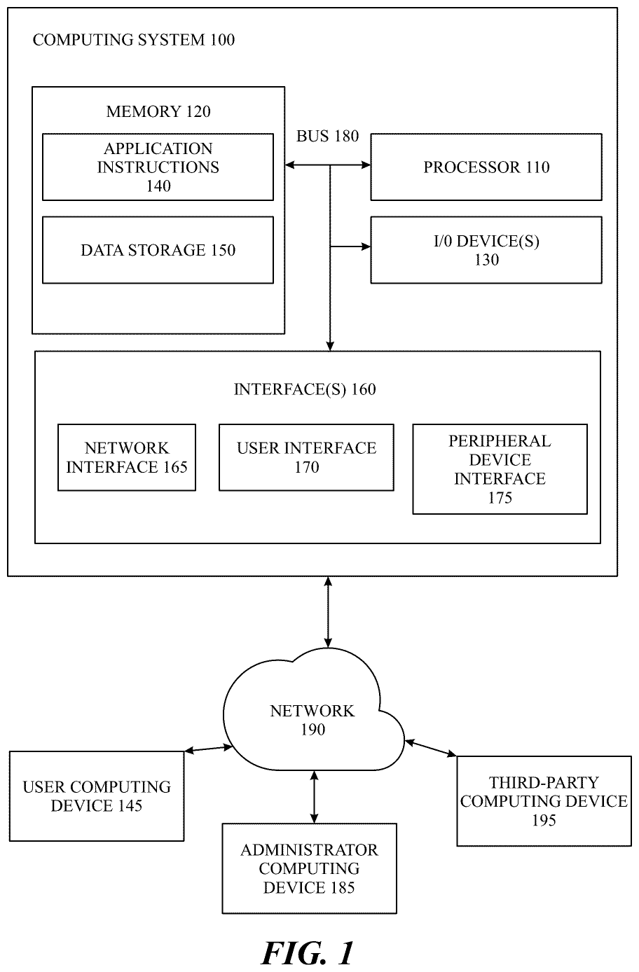

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system, including requesting service appointments, determining location data, communicating between customer and service provider devices, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

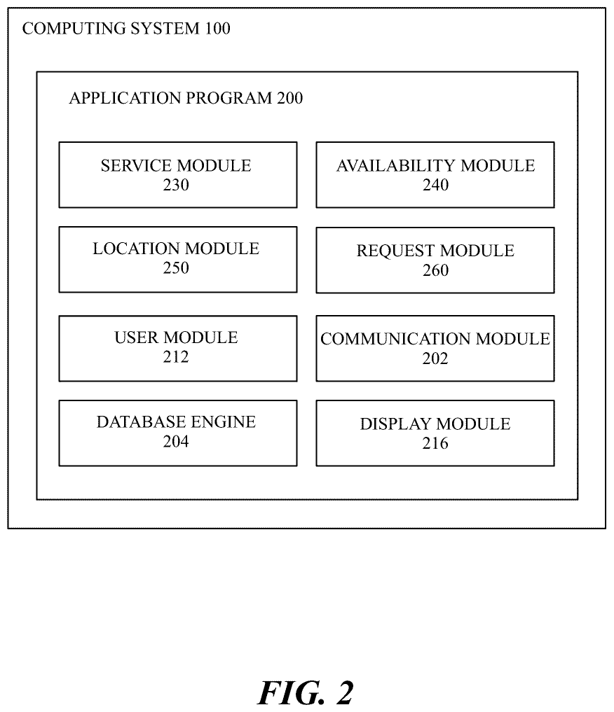

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a service module 230, an availability module 240, a location module 250, a request module 260, a communication module 202, a database engine 204, a user module 212, and a display module 216.

In some embodiments, the service module 230 is configured to determine and monitor service provider schedule, location, and availability data. The service module 230 may be configured to be in operative communication with, for example, third-party calendar or scheduling APIs, location tracking APIs, etc.

In some embodiments, the availability module 240 is configured to determine service provider availability based on information received from the service module 230, the location module 250, and the request module 260. The availability module 240 may be configured to use rule-based logic to schedule service requests based on the relative proximity of a service provider to a service request (determined via the location module 250), the service provider's existing schedule, and the service provider's areas of expertise compared to the service type requested. In some embodiments, the availability module 240 is configured to generate a list of currently available service providers based on real-time availability and geographic proximity to the user using rule-based logic. In some embodiments, the request module 260 is configured to receive service provider input as at least one of a confirmation or a denial of the appointment.

In some embodiments, the location module 250 is configured to determine a service location or current location of the one or more service providers via global positioning system triangulation or based on the location information received via a service provider vehicle or computing device.

In some embodiments, the request module 260 is configured to receive a service request from a customer to schedule service comprising at least one preferred time and location. The request may be received via an application extension or web portal in operable communication with the application program 200. The request module 260 may receive requests to schedule an event from a customer comprising one or more customer preferences, including the type of service desired, such as plumbing, electrical, HVAC, etc. Types of service may include, but are not limited to, HVAC, electrical, plumbing, pest control, locksmith, house cleaning, pool service, handyman, dumpster rental, lawn mowing and landscaping, garage door repair, sprinkler/irrigation, pressure washing, moving, tree trimming, fence repair and installation, air duct cleaning, window washing, and foundation repair need. In this way, the request module 260 is configured to receive a user input of a service need from a user and user input requesting an appointment. The request module 260 may also be configured to communicate a notification to the user of the at least one of the confirmation or the denial of the appointment based on service provider input to the availability module 240.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another. In some embodiments, the communication module 202 may be configured to receive user reviews of services that have been provided.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

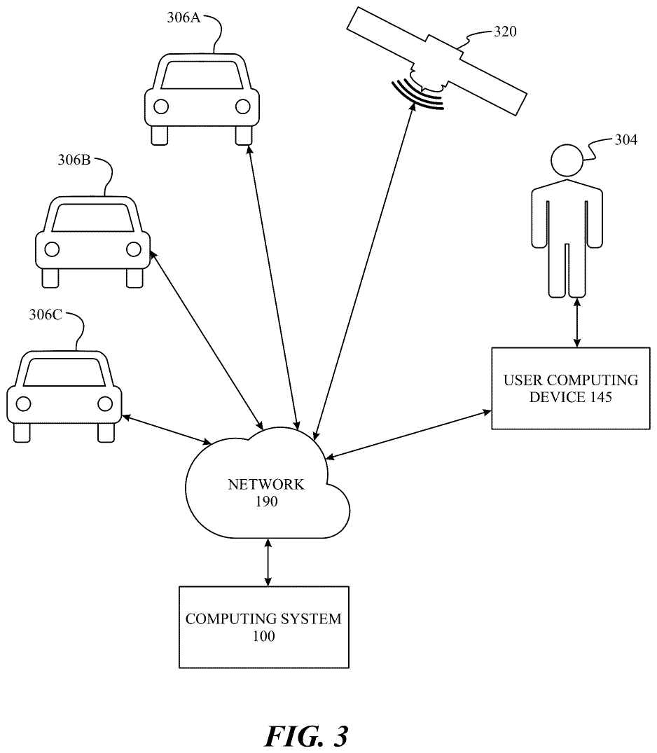

FIG. 3 illustrates a method for scheduling home services through an online portal including communicating a user input of a service need from a user 304 via a user computing device 145 in operable communication with the computing system 100 corresponding to the computing system 100 of FIGS. 1 and 2 over network 190, corresponding to network 190 of FIG. 1. Computer system 100 may be in operable communication with, for example, GPS services 320 and service provider devices 306A, 306B, and 306C. GPS services 320 may be configured to, in cooperation with the location module 250 of FIG. 2, identify geographic proximity of the service provider devices 306A, 306B, and 306C to the user computing device 145. Computer system 100 may be configured to facilitate communication between the user computing device 145 and service provider devices 306A, 306B, and 306C via the communication module 202 of FIG. 2. In some embodiments, service provider devices 306A, 306B, and 306C may be configured to communicate service scheduling data to the computer system 100 via availability module 240. As previously described, the availability module 240 is configured to determine service provider availability based on information received from the service module 230 via service provider devices 306A, 306B, and 306C, the location module 250 via GPS services 320, and the request module 260 from user 304. The availability module 240 may be configured to use rule-based logic to schedule service requests based on the relative proximity of a service provider devices 306A, 306B, and 306C to a user 304 submitting a service request (determined via the location module 250), the service provider's existing schedule, and the service provider's areas of expertise compared to the service type requested. In some embodiments, the availability module 240 is configured to generate a list of currently available service providers based on real-time availability and geographic proximity to the user using rule-based logic.

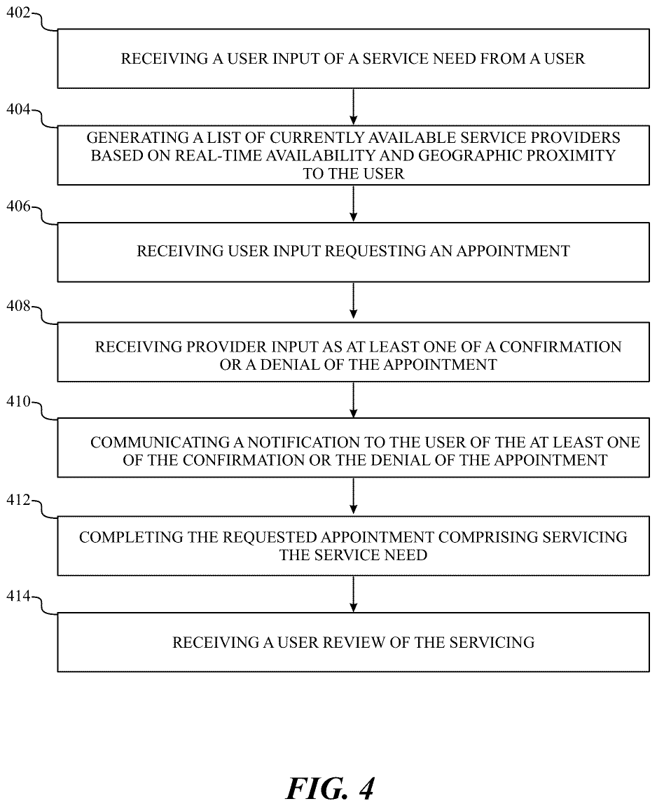

FIG. 4 illustrates a method of online and mobile home services scheduling, according to some embodiments. The method may include, in step 402, receiving, via the user request module 260 of FIG. 2, a user input of a service need from a user. In step 404, the method may include generating, via the availability module 240 and location module 250 of FIG. 2, a list of currently available service providers based on real-time availability and geographic proximity to the user. In step 406, the method may include receiving, via the request module 260 of FIG. 2, user input requesting an appointment. In step 408, the method may include receiving, via the request module 260 of FIG. 2, provider input as at least one of a confirmation or a denial of the appointment. In step 410, the method may include communicating, via the communication module 202 of FIG. 2, a notification to the user of the at least one of the confirmation or the denial of the appointment. In step 412, the method may include completing the requested appointment comprising servicing the service need. In step 414, the method may include receiving, via the communication module 202 of FIG. 2, a user review of the servicing.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented method of online and mobile home services scheduling comprising:
receiving, via a computing device, a user input of a service need from a user;
generating, via the computing device, a list of currently available service providers based on real-time availability and geographic proximity to the user;
receiving, via the computing device, user input requesting an appointment;
receiving, via the computing device, provider input as at least one of a confirmation or a denial of the appointment;
communicating, via the computing device, a notification to the user of the at least one of the confirmation or the denial of the appointment;
completing the requested appointment comprising servicing the service need; and
receiving, via the computing device, a user review of the servicing.

2. A computer-implemented method of claim 1, wherein the list of currently available service providers comprises providers not currently performing a service.

3. A computer-implemented method of claim 1, wherein the list of currently available service providers comprises providers available on the same calendar day as the user input selection of a service need from the user.

4. A computer-implemented method of claim 1, wherein the list of currently available service providers comprises providers immediately available to provide a service.

5. A computer-implemented method of claim 1, wherein the list of currently available service providers comprises information indicating service provider travel-time to the service need.

6. A computer-implemented method of claim 1, wherein the service need is a home service need.

7. A computer-implemented method of claim 1, wherein the generating the list of currently available service providers comprises service provided-maintained real-time availability and geographic proximity to the user.

8. A computer-implemented method of claim 1, wherein the generating the list of currently available service providers comprises storing service provider real-time availability data in a database and generating the list based on service provider proximity to the user.

9. A system comprising:
at least one computing device in operable communication with a network;
an application server in operable communication with the at least one computing device over the network, the application server configured to host an application program configured to:
receive a user input of a service need from a user;
generate a list of currently available service providers based on real-time availability and geographic proximity to the user;
receive user input requesting an appointment;
receive provider input as at least one of a confirmation or a denial of the appointment; and
communicate a notification to the user of the at least one of the confirmation or the denial of the appointment.

10. A system of claim 9, wherein the list of currently available service providers comprises providers not currently performing a service.

11. A system of claim 9, wherein the list of currently available service providers comprises providers available on the same calendar day as the user input selection of a service need from the user.

12. A system of claim 9, wherein the list of currently available service providers comprises providers immediately available to provide a service.

13. A system of claim 9, wherein the list of currently available service providers comprises information indicating service provider travel-time to the service need.

14. A system of claim 9, wherein the service need is a home service need.

15. A system of claim 14, wherein the home service need comprises at least one of an HVAC, electrical, plumbing, pest control, locksmith, house cleaning, pool service, handyman, dumpster rental, lawn mowing and landscaping, garage door repair, sprinkler/irrigation, pressure washing, moving, tree trimming, fence repair and installation, air duct cleaning, window washing, foundation repair need.

16. A system of claim 9, wherein the generating the list of currently available service providers comprises an application programming interface in operative communication with a third-party provider service comprising service provider real-time availability and geographic proximity to the user.

17. A system of claim 9, wherein the generating the list of currently available service providers comprises storing service provider real-time availability data in a database and generating the list based on service provider proximity to the user.

18. The system of claim 9, wherein the application instructions are further executable to:
complete the requested appointment comprising servicing the service need; and
receive a user review of the servicing.

19. A software product comprising at least one computer readable storage media having application instructions collectively stored on the at least one computer readable storage media, the application instructions executable to:
receive a user input of a service need from a user;
generate a list of currently available service providers based on real-time availability and geographic proximity to the user;
receive user input requesting an appointment;
receive provider input as at least one of a confirmation or a denial of the appointment; and
communicate a notification to the user of the at least one of the confirmation or the denial of the appointment.

20. The software product of claim 19, wherein the application instructions are further executable to:
complete the requested appointment comprising servicing the service need; and
receive a user review of the servicing.
